(19) United States
(12) Patent Application Publication
(10) Pub. No.: US 2026/0234017 A1
(43) Pub. Date: Aug. 13, 2026

(54) A METHOD FOR THE PREPARATION OF ALUMINA

(71) Applicant: PLAYA ONE PTY LTD, Morley, Western Australia (AU)

(72) Inventor: Roland GOTTHARD, Morley (AU)

(73) Assignee: PLAYA ONE PTY LTD, Morley, Western Australia (AU)

(21) Appl. No.: 19/156,570

(22) PCT Filed: Feb. 15, 2024
(86) PCT No.: PCT/AU2024/050103

§ 371 Date: Aug. 14, 2025

(30) Foreign Application Priority Data
Feb. 16, 2023 (AU) 2023900392

(51) Int. Cl. C01F 7/32; B01D 9/00; C01F 7/22; C01F 7/24; C01F 7/26; C01F 7/306; C05C 3/00; C05D 1/00; C22B 1/02; C22B 1/24; C22B 3/08; C22B 3/44; C22B 21/00

(52) U.S. Cl. CPC C01F 7/32; B01D 9/0054; C01F 7/22; C01F 7/24; C01F 7/26; C01F 7/306; C05C 3/00; C05D 1/00; C22B 1/02; C22B 1/24; C22B 3/08; C22B 3/44; C22B 21/0007; C22B 21/0015; B01D 2009/0086; C01P 2006/80

(57) ABSTRACT

A method for the preparation of alumina from alunite, the method comprising the steps of: (i) attrition of an alunite material; (ii) washing and settling the alunite material to reduce sodium content; (iii) acid leaching and roasting the Na-reduced alunite material; (iv) passing the product of the acid leach and roast step (iii) to a water leaching step to produce a liquid product comprising aluminium and potassium; (v) subjecting the liquid product of step (iv) to a precipitation step to precipitate an aluminium salt; (vi) purifying the aluminium salt; and (vii) subjecting the purified aluminium salt to a calcination step to produce alumina.

### FIELD OF THE INVENTION

The present invention relates to a method for the preparation of alumina. More particularly, the method of the present invention utilises as a starting material, alunite.

Still more particularly, the alumina prepared by the method of the present invention is intended to be utilised as a high purity alumina (HPA).

### BACKGROUND ART

Traditionally, highly purified form of alumina (Al₂O₃), also referred to as High Purity Alumina (HPA) has been prepared by methods such as refining of alumina-bearing minerals (aluminium hydroxides) and hydrolysis of aluminium alkoxide. These traditional methods involve high costs due to the energy intensive process to produce hydroxides from bauxite as well as high consumption of aluminium metal and alcohol.

Presently, the primary method of preparing HPA is treating kaolin ores with hydrochloric acid, then refining the treated ores using traditional technologies developed in the 1920-40s, namely HCl gas sparging or aluminium chloride hexahydrate (ACH) crystallisation.

Australian Innovation patent application No. 2019100630 describes a method for the preparation of alumina from aluminous material, the method comprising the steps of treating the aluminous material to reduce particle size and increase alumina content, calcining the aluminous material, and subsequently leaching the aluminous material with HCl to provide a pregnant liquor. The pregnant leach is then precipitated to ACH by adding HCl gas and subsequently, the precipitated ACH is calcined to provide alumina, whereby HCl is recycled. The aluminous material is preferably kaolin. Despite lower production costs compared to the traditional method(s) from bauxite, producing HPA from kaolin requires substantial HCl consumption. This is an economic concern given the price of HCl and generally low availability in large volumes.

With a growing demand for HPA, economic and environmental concerns are becoming of increasing importance, in addition to being able to produce HPA in sufficient quantities.

Hence, there has been much research directed to methods utilising various alumina-bearing minerals to prepare HPA, whilst being economical.

Alunite is a source of potassium and alumina, and due to its high aluminium content, it has been utilised to prepare Smelter Grade Alumina (SGA) or metallurgical grade alumina. Typically, the potassium component is directed to produce muriate of potash (MOP or KCl) or sulfate of potash (SOP or K₂SO₄), SOP is the preferred potassium fertiliser chemical as it is chlorine-free and comprises both, potassium and sulfur.

Historical processes for the treatment of alunite include reductive pyrometallurgy, the potash-alkaline method and the soda alkali method.

### Reductive Pyrometallurgy

In this method, the ore after crushing, grinding and roasting is subject to a recovery roasting at a temperature greater than 560-580° C. with a reducing agent:

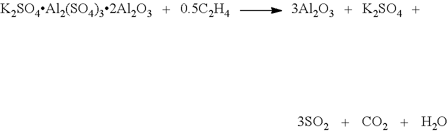

The preferred reducing agents for the reaction are diesel fuel or gaseous sulfur and the SO₂ resulting from the reaction is used to produce sulfuric acid. The complete process of recovery takes place at temperatures over 580° C.

This method had several major drawbacks including low yield of alumina in the product and significant damage to the environment, particularly by production of excess sulfur in the form of sulfuric acid as sulfur remains in net oversupply.

### Potash-Alkaline Method

The potash-alkaline method comprises roasting the alunite at 550° C., and subsequently leaching the roasted alunite with a potassium carbonate solution:

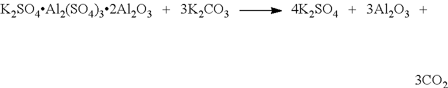

This reaction effectively converts potassium carbonate to potassium sulfate (SOP) and neutralises or uses the excess sulfur in the alunite as a by-product. The insoluble residue contains active alumina (γ-Al₂O₃) which is then processed using the Bayer out-of-autoclave process to produce alumina and quartz sand. Despite the high yield of alumina in the product (up to 90%), this method uses high volumes of potassium carbonate, a scarce and expensive auxiliary raw material.

### Soda-Alkaline Method

More recently, US 2021/0071281 A1 describes an alternative method of treating alunite ore. This method modifies the potash alkali method by substituting the potassium carbonate solution with a sodium carbonate solution, and subsequently reacting the produced sodium sulfate with kainite (KCl) to produce additional SOP and by-product, sodium salt:

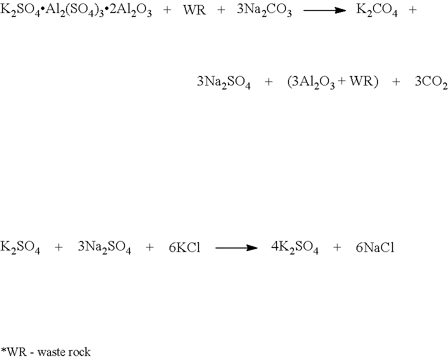

Alumina is recovered by treating the Al₂O₃ via the Bayer process and the yield of alumina in the product is up to 90%.

Other methods to recover alumina from alunite has been explored, including:
Bayer process pressure leach with NaO to produce SOP and alumina;
Potassium hydroxide leaching to produce SOP and alumina (CN 101913633 B);
CaF smelting to produce cryolite, alumina and SO₂ gas; and
Sulfuric or hydrochloric acid with potassium fluoride or fluoro silicic acid addition.

Whilst the methods described above are able to provide alumina, uneconomical and environmentally hazardous steps such as high temperature calcination and the Bayer process are necessary due to the high content of sulfur trioxide (SO₃) and silica in most alunite ores. Surprisingly, the Applicant has identified that lacustrine alunite, in particular alunite from salt lakes in Western Australia, may be a potential ore deposit suited to produce highly purified alumina. The lacustrine alunite is found to be higher in aluminium and potassium content, lower in silica, Fe₂O₃, sulfur and sodium content, in comparison to hard rock from other places around the world such as Azerbaijan.

The method of the present invention has as one object thereof to overcome substantially the abovementioned problems of the prior art, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification, unless the context requires otherwise, the word “comprise” or variations such as “comprises” or “comprising”, will be understood to imply the inclusion of a stated integer or group of integers but not the exclusion of any other integer or group of integers.

Each document, reference, patent application or patent cited in this text is expressly incorporated herein in their entirely by reference, which means that it should be read and considered by the reader as part of this text. That the document, reference, patent application, or patent cited in this text is not repeated in this text is merely for reasons of brevity.

### DISCLOSURE OF THE INVENTION

In accordance with the present invention there is provided a method for the preparation of alumina from alunite, the method comprising the steps of:
(i) Attrition of an alunite material;
(ii) Washing and settling the alunite material to reduce sodium content;
(iii) Acid leaching and roasting the Na-reduced alunite material;
(iv) Passing the product of the acid leach and roast step (iii) to a water leaching step to produce a liquid product comprising aluminium and potassium;
(v) Subjecting the liquid product of step (iv) to a precipitation step to precipitate an aluminium salt;
(vi) Purifying the aluminium salt; and
(vii) Subjecting the purified aluminium salt to a calcination step to produce alumina.

Preferably, potassium is recovered as a by-product after the precipitation step (v).

Preferably, the alumina is in the form of high purity alumina (HPA).

Preferably, the alunite material is lacustrine alunite in clay form.

Still preferably, the alunite material in clay form is homogenised during the attrition step (i).

Preferably, sodium content is reduced by removing NaCl salt as brine. Still preferably, the sodium content in the Na-reduced alunite material is less than about 1%. Still yet preferably, the sodium content in the Na-reduced alunite material is between about 0.66% to 0.72%

Preferably, the settling step is conducted in a settling pond. Still preferably, process water used during the washing and settling step is recirculated.

In one form of the present invention, the settling step is conducted using a flocculant.

The acid leaching is preferably conducted using any one of:
a. sulfuric acid;
b. oxalic acid;
c. hydrochloric acid; or
d. nitric acid.

In one form of the present invention, the acid leaching is conducted using sulfuric acid. Preferably, the concentration of sulfuric acid ranges between about 650 to 750 kg/tonne.

Preferably, the roasting step is conducted at a temperature between 150° C. and 300° C. under atmospheric pressure. Still preferably, the roasting step is conducted at a temperature between 250° C. and 300° C. under atmospheric pressure.

Preferably, the roasting in step (iii) is conducted over a period of about 1 to 4 hours.

Preferably, solid residue from the water leaching step (iv) comprises silicates. Still preferably, the solid residue further comprises refractory oxides including those of zirconium and titanium.

Preferably, the precipitation step (v) comprises a double salt reaction. Still preferably, the double salt reaction is conducted using a salt.

In one form, the salt is ammonium sulphate, (NH₄)₂SO₄. Preferably, the ammonium sulphate is added at a rate between 10 g/L and 100 g/L inclusive.

In another form, the salt is one or more of ammonia (NH₃), ammonium hydroxide (NH₄OH) and ammonium carbonate ((NH₄)₂CO₃).

Preferably, the precipitation step (v) further comprises a solvent displacement reaction. Still preferably, the solvent displacement reaction is conducted using an alcohol.

The solvent displacement reaction is preferably conducted using any one of:
a. ethanol;
b. methanol; or
c. isopropanol.

In one form of the present invention, the solvent displacement reaction is conducted using ethanol. Preferably, the ethanol is added at a rate of about 5% to 25% by weight. Further preferably, the ethanol is added at a rate of around 10% by weight.

Preferably, ethanol is recovered during the precipitation step (v).

Preferably, an ammonium alum salt is precipitated in the precipitation step (v).

Preferably, the by-product recovered during the precipitation step (v) is a fertiliser chemical.

Preferably, ethanol is recovered prior to the recovery of the by-product.

In one form, the purification step (vi) comprises:
a. dissolving the aluminium alum salt in water; and
b. gas sparging with gaseous hydrochloric acid to produce aluminium chloride hexahydrate (ACH) salt.

Preferably, the concentration of the gaseous hydrochloric acid to produce the purified aluminium salt is greater than or equal to about 360 g/L in STP conditions.

Preferably, solid/liquid ratio of the aluminium salt to water is about 25% during step (vi).

Preferably, the calcination step (vii) comprises two steps:
a. initial heating to about 350° C.; and
b. final calcination to about 1200° C.

In one form of the present invention, the purity of the high purity alumina (HPA) is at least 99.95%. Preferably, the purity of the high purity alumina (HPA) is at least 99.99%.

In one form of the present invention, the oxalic acid leach under atmospheric pressure is preferably conducted at a temperature of about 90° C. Still preferably, the residence time ranges between about 1 to 4 hours. Still yet preferably, pulp density of slurry after the oxalic acid leach ranges between about 15 to 20%.

In this form of the present invention, the water leaching step (iv) recovers aluminium and potassium oxalates and sulfates as soluble salts.

In another form of the present invention, the hydrochloric acid leach under atmospheric pressure is preferably conducted at a temperature ranging between about 80 to 95° C. Still preferably, the concentration of the hydrochloric acid ranges between about 3 mol/L to 6 mol/L. Still yet preferably, the hydrochloric acid leach under atmospheric pressure is preferably conducted over a period of about 1 to 5 hours.

In this form, selectively removed chlorine from a scrubber during the calcination step (vii) is returned to the leaching step (iii) of the process to reduce consumption of HCl and substantially neutralise emissions.

In a yet another form of the present invention, the nitric acid leach under atmospheric pressure is preferably conducted at a temperature of about 90° C. Still preferably, the residence time ranges between about 1 to 4 hours. Still yet preferably, pulp density of slurry after the nitric acid leach ranges between about 15 to 20%. Still yet further preferably, the concentration of the nitric acid ranges between about 3 mol/L to 6 mol/L.

In this form, aluminium nitrate nonahydrate is precipitated in the precipitation step (v). Preferably, aluminium nitrate nonahydrate is precipitated using nitric acid or gaseous nitric acid.

In this form, the purification step (vi) comprises:
a. dissolving the aluminium nitrate nonahydrate in water; and
b. re-precipitation.

Still preferably, the aluminium nitrate nonahydrate is subjected to a calcination step to produce an alumina powder product. Still yet preferably, nitric acid is regenerated and recycled to the acid leaching and roasting step.

### DESCRIPTION OF THE DRAWINGS

The present invention will now be described, by way of example only, with reference to one embodiment thereof and the accompanying drawings, in which:—

FIG. 1 is a flow sheet depicting a method for the preparation of alumina from alunite in accordance with the present invention.

### BEST MODE(S) FOR CARRYING OUT THE INVENTION

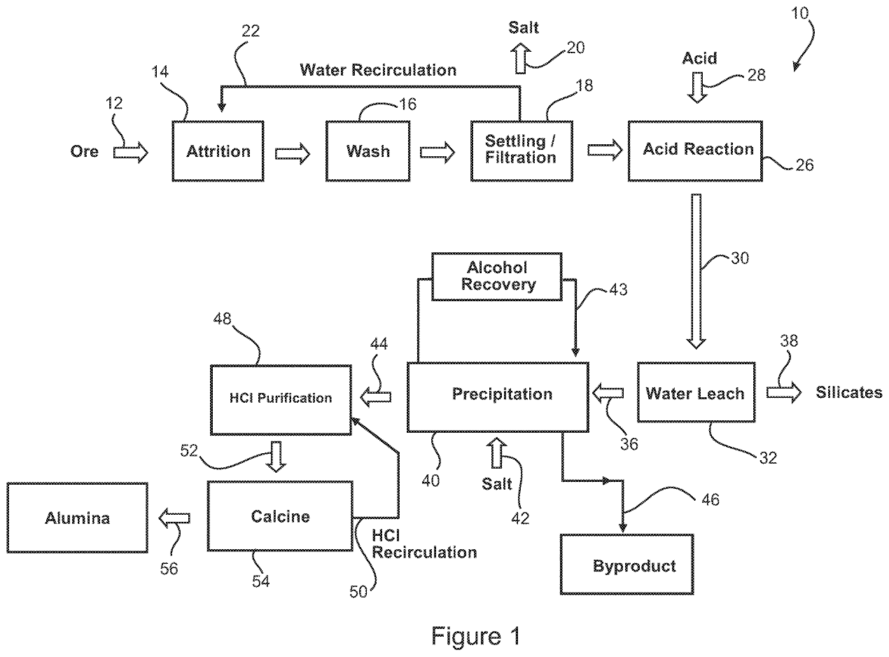

In FIG. 1 there is shown a method 10 for the preparation of alumina, for example a high purity alumina (HPA), from an alunite in accordance with the present invention. The method 10 comprises an attrition step 14; washing 16 and settling step 18; acid leaching and roasting step 26; water leaching step 32 to recover aluminium and potassium ions into solution 36 and remove solid residue 38 comprising silicates; precipitation step 40 using a salt 42 and an alcohol 43 to precipitate the ammonium salt 44; a purification step 48 which, for example comprises dissolution in water and gaseous HCl 50 sparge; and a calcination step 54 to produce the alumina 56. The method 10 further comprises recovering potassium as a by-product 46 after the precipitation step 40 and HCl recirculation from the calcination step 54 to the HCl purification step 48.

Prior to the attrition step 14, alunite in the form of a raw clay 12 is dug out from a lake bed in accordance to any digging method known in the art.

Based on metallurgical test work on a deposit of alunite from a salt lake in Western Australia, the content of the deposit is 27% aluminium, 5.8-6.3% potassium, 20-23% silica, 2.5% Fe₂O₃, 12% sulfur and 2.5-3.5% sodium.

The attrition step 14 is conducted using a wet attritioning cell, to homogenise the raw alunite clay 12. The attrition step 14 is conducted to disaggregate the mineral particles and allow efficient washing and chemical treatment that follow.

The purpose of the washing 16 and settling step (ii) 18 is to strip NaCl salt 20 as brine. Preferably, the sodium content of about ~2.5 to 3.5% in the raw alunite clay 12 is reduced to a range between about ~0.6 to 0.7%.

Process water 22 used during the washing 16 and settling step 18 is recirculated.

It will be appreciated by those skilled in the art that the residence time of settling the alunite clay is around two weeks as it is an energy neutral process. The settling step 18 is preferably conducted in a settling pond.

The settling step 18 is conducted using a flocculant 24. The use of flocculant 24 is able to shorten the time consumed during the settling of the alunite clay.

The acid leaching and roasting step 26 is conducted using sulfuric acid 28. Preferably, the concentration of sulfuric acid 28 ranges between about 650 to 750 kg per tonne.

The product of the sulfuric acid leach in the form of a paste is roasted in a ‘pug roast’ process. Preferably, the roasting step is conducted at a temperature of about 300° C. under atmospheric pressure. The residence time of the roasting step preferably ranges between about 1 to 4 hours.

The product of the sulfuric acid leach and roast 30 is subjected to a water leach 32. The purpose of the water leaching step (iv) 32 is to recover the aluminium and potassium sulfates into solution 36. Preferably, the water leach residue 38 comprises silicates and refractory oxides, for example, oxides of zirconium and titanium.

A liquid product 36 comprising sulfates of aluminium and potassium as well as associated iron, calcium and sodium salts, is thereby produced from the water leaching step (iv) 32. The liquid product 36 is subjected to a precipitation step (v) 40.

The liquid product 36 is concentrated to at least 25 g/L of aluminium and is then cooled to about 70° C. The liquid product 36 is then subjected to a double salt reaction using ammonium sulphate 42 added at a rate of about 40 g/L (NH₄)₂SO₄ to maintain a pH of less than about 2.

Using ammonium sulphate amongst other salts reduce consumption of sulphuric acid whilst also preventing the iron and calcium in the liquid product 36 from precipitating. For example, the ammonium sulphate does not neutralise the acid in the liquid product 36 and thus the acid may be recycled into the acid reaction step 26.

In another form, double salt reaction may be conducted using one or more of ammonia, ammonium hydroxide and ammonium carbonate, at a pH of about 3 to 8 and at a temperature between 0° C. and 100° C., preferably at about 90° C. For example, using ammonium carbonate produces an ammonium sulphate solution, potassium salt and iron crystal, whereby the ammonium sulphate solution can then be recovered leaving the remaining potash and iron crystal.

The solution resulting from the double salt reaction is cooled to about 40° C. and is subjected to a solvent displacement reaction. The solvent displacement reaction is conducted using ethanol 43, added at a rate of about 10% by weight. The addition of ethanol precipitates an aluminium salt 44 without raising the pH.

Ethanol 43 is recovered during the precipitation step (v) via distillation at about 90° C. It will be appreciated by those skilled in the art that any common method known in the art may be used to recover ethanol.

The aluminium salt 44 precipitated from the precipitation step (v) 40 is an ammonium alum salt.

It will be appreciated by those skilled in the art that the conditions of the precipitation step (v) 40, for example the amount of ammonium sulphate 42 added, the rate at which ethanol 43 is added, target pH level and the residence time, are adjusted to a level of molar equality between ammonium and aluminium (at around 1:1) for efficient recovery of the aluminium salt 44. The amount of ammonium sulphate 42 added affects the recovery of ammonium alum salt (e.g. loss of aluminium) as too little will lead to inefficient precipitation whilst too much will cause ammonium alum salt to precipitate prematurely. The rate of ethanol 43 added ranges between 5 to 25% by weight.

The liquid solution 46 from the solid liquid separation after the precipitation step (v) 40 is recovered as a by-product. It is envisaged that this liquid solution 46 may be used to recover an ammonium potassium fertiliser chemical.

The precipitated aluminium salt 44 recovered from the solid liquid separation after the precipitation step (v) 40, is dissolved in water. The solid/liquid ratio of the aluminium salt to water is about 25%.

The aluminium salt 44 dissolved in water is gas sparged using gaseous HCl 50 to precipitate aluminium chloride hexahydrate (ACH) salt 52, leaving sulfur, iron, calcium, sodium, potassium and minor contaminants in solution. The target HCl concentration to achieve precipitation is greater than or equal to about 360 g/L in STP conditions.

It is envisaged that additional purification step(s) of dissolving in water and re-precipitation may be utilised to produce ACH with a desired purity.

The ACH salt 52 is subjected to a calcination step (vii) 54 to produce an alumina powder product 56. Preferably, the calcination step (vii) 54 comprises of two steps, initial heating to about 350° C. and final calcination to about 1200° C.

Chlorine from the ACH salt 52 is separately recovered in a scrubber.

In a further embodiment of the present invention, the acid leaching is conducted using oxalic acid. Oxalic acid leach has been demonstrated by the Applicant to extract aluminium, potassium but less iron, sodium and calcium compared to the sulfuric acid leach.

The oxalic acid leach under atmospheric pressure is conducted at a temperature of about 90° C. and the residence time ranges between about 1 to 4 hours. The pulp density of slurry after the oxalic acid leach is between about 15 to 20%.

The purpose of the water leaching step (iv) is to recover aluminium and potassium oxalates and sulfates as soluble salts from the leach slurry of the oxalic acid leaching and roasting step.

In a further embodiment of the present invention, the acid leaching is conducted using hydrochloric acid. Hydrochloric acid leach has been demonstrated to extract aluminium, potassium but also, iron and calcium.

The hydrochloric acid leach under atmospheric pressure is conducted at a temperature ranging between about 80° C. to 95° C. The concentration of the hydrochloric acid ranges between about 3 mol/L to 6 mol/L.

Aluminium is recovered from the product of step (iv) by solid liquid separation to remove silicates as solid residues. Solid liquid separation may be achieved by way of simple filtration. Liquor resulting from the solid liquid separation is subjected to the precipitation step (v), dissolved in water and then gas sparged to precipitate aluminium chloride hexahydrate (ACH).

The ACH salt 52 is subjected to a calcination step (vii) 54 to produce an alumina powder product 56. The calcination step (vii) 54 comprises of two steps, initial heating to about 350° C. and final calcination to about 1200° C. Selectively removed chlorine from a scrubber during the calcination step 54 is returned to the purification step (vi) 48 via HCl recirculation to reduce consumption of HCl and neutralise emissions.

In a still further embodiment of the present invention, the acid leaching is conducted using nitric acid. Nitric acid leaching has been demonstrated by the Applicant to extract aluminium and potassium, but less iron, sodium and calcium compared to the sulfuric acid leach.

The nitric acid leach is conducted under atmospheric pressure at a temperature of about 90° C. and the residence time ranges between about 1 to 4 hours. The pulp density of slurry after the nitric acid leach is between about 15 to 20%. The concentration of the nitric acid is between about 3 mol/L to 6 mol/L.

Aluminium nitrate nonahydrate is precipitated using nitric acid or gaseous nitric acid. The precipitated aluminium nitrate nonahydrate is recovered, for example, by filtration.

It is envisaged that additional purification step(s) of dissolving in water and re-precipitation may be utilised to produce aluminium nitrate nonahydrate with a desired purity.

The aluminium nitrate nonahydrate is subjected to a calcination step (vii) to produce an alumina powder product. The calcination step (vii) comprises of two steps, initial heating to about 350° C. and final calcination to about 1200° C.

The initial heating to about 350° C. releases nitric oxides which may be scrubbed through water to regenerate nitric acid. The regenerated nitric acid is recycled to a nitric acid feed tank for the acid leaching and roasting step.

The final calcination to about 1200° C. produces alumina powder.

It is to be understood that other processes for the regeneration of acid may be utilised without departing from the scope of the present invention.

Modifications and variations such as would be apparent to the skilled addressee are considered to fall within the scope of the present invention.

1. A method for the preparation of alumina from alunite, the method comprising the steps of:
(i) Attrition of an alunite material;
(ii) Washing and settling the alunite material to reduce sodium content;
(iii) Acid leaching and roasting the Na-reduced alunite material;
(iv) Passing the product of the acid leach and roast step (iii) to a water leaching step to produce a liquid product comprising aluminium and potassium;
(v) Subjecting the liquid product of step (iv) to a precipitation step to precipitate an aluminium salt;
(vi) Purifying the aluminium salt; and
(vii) Subjecting the purified aluminium salt to a calcination step to produce alumina.

2. The method according to claim 1, wherein the alumina is in the form of high purity alumina (HPA).

3. The method according to claim 1, wherein the alunite material is a lacustrine alunite in clay form.

4-9. (canceled)

10. The method according to claim 1, wherein the acid leaching is conducted using any one of:
a) sulfuric acid;
b) oxalic acid;
c) hydrochloric acid; or
d) nitric acid.

11. The method according to claim 10, wherein the concentration of sulfuric acid used in the acid leaching ranges between about 650 to 750 kg/tonne.

12. The method according to claim 1, wherein the roasting step is conducted at a temperature between 150° C. and 300° C. under atmospheric pressure.

13. (canceled)

14. The method according to claim 1, wherein the roasting in step (iii) is conducted over a period of about 1 to 4 hours.

15. The method according to claim 1, wherein the precipitation step (v) comprises a double salt reaction using a salt.

16. The method according to claim 15, wherein the salt is ammonium sulphate, (NH₄)₂SO₄.

17. The method according to claim 15, wherein the salt is one or more of ammonia (NH₃), ammonium hydroxide (NH₄OH) and ammonium carbonate ((NH₄)₂CO₃).

18. The method according to claim 1, wherein the precipitation step (v) further comprises a solvent displacement reaction.

19. The method according to claim 18, wherein the solvent displacement reaction is preferably conducted using any one of:
a) ethanol;
b) methanol; or
c) isopropanol.

20. The method according to claim 19, wherein the solvent displacement reaction is conducted using ethanol and the ethanol is added at a rate of about 5% to 25% by weight, preferably at a rate of about 10% by weight.

21. (canceled)

22. The method according to claim 1, wherein a by-product is recovered after the precipitation step (v).

23. The method according to claim 22, wherein the by-product is a fertiliser chemical.

24. The method according to claim 1, wherein an ammonium alum salt is precipitated in the precipitation step (v).

25. The method according to claim 24, wherein the purification step (vi) comprises:
a) dissolving the aluminium alum salt in water; and
b) gas sparging with gaseous hydrochloric acid to produce aluminium chloride hexahydrate (ACH) salt.

26-28. (canceled)

29. The method according to claim 2, wherein the purity of the high purity alumina (HPA) is at least 99.95%.

30. The method according to claim 2, wherein the purity of the high purity alumina (HPA) is at least 99.99%.

31-35. (canceled)

36. The method according to claim 1, wherein a selectively removed chlorine from a scrubber during the calcination step (vii) is returned to the leaching step (iii).

37-42. (canceled)
